(19) United States
(12) Patent Application Publication
(10) Pub. No.: US 2017/0247172 A1
(43) Pub. Date: Aug. 31, 2017

(54) Containers for Unit Dose Products

(71) Applicant: MONOSOL, LLC, Merrillvile, IN (US)

(72) Inventors: David Brian Edwards, Old town Stevenage, Hertfordshire (GB); David M. LEE, Crown Point, IN (US)

(73) Assignee: MONOSOL, LLC, Merriville, IN (US)

(21) Appl. No.: 15/515,044

(22) PCT Filed: Oct. 2, 2015
(86) PCT No.: PCT/US15/53624

§ 371 Date: Mar. 28, 2017

Related U.S. Application Data
(60) Provisional application No. 62/059,558, filed on Oct. 3, 2014.

(51) Int. Cl. B65D 83/04; B65D 75/42; C11D 17/04; B65D 65/46

(52) U.S. Cl. CPC B65D 83/0472; B65D 65/466; B65D 75/42; C11D 17/042

(57) ABSTRACT

A product container (10) including a protective housing (12) and a web (14) of unit dose products (40) is disclosed. The web is arranged in a hollow interior (32) of the protective housing. The web includes a plurality of water-soluble or otherwise degradable (e.g., UV degradable) pouches (40) removably attached to a flexible carrier sheet. Each of the water-soluble pouches contains at least one cleaning composition (44). The web is either formed in a roll or a z-folded configuration with a plurality of folds. Also disclosed is a product container including a protective sleeve (212) filled with a plurality of water-soluble pouches (216). Each of the water-soluble pouches contains at least one cleaning composition (234) and forms a friction fit with one or more interior walls of the water-insoluble protective sleeve. A re-sealable plug (222, 224) is arranged to cover an open end of the water-insoluble protective sleeve.

### CROSS REFERENCE TO RELATED APPLICATIONS

The benefit under 35 U.S.C. §119(e) of U.S. Provisional Patent Application Ser. No. 62/059,558 filed Oct. 3, 2014, is hereby claimed, and the disclosure thereof is hereby incorporated by reference herein.

### FIELD OF DISCLOSURE

The present disclosure generally relates to product containers, and more particularly, to containers for storing and dispensing unit dose cleaning products.

### BACKGROUND

Unit dose cleaning products for dishwashing and clothes washing applications have become more commonplace in recent years. Unit dose cleaning products offer several benefits including preventing skin contact with potentially irritating cleaning compositions, freeing the consumer from having to measure an appropriate amount of a cleaning composition, and avoiding spills. Unit dose cleaning products can be sold individually or in small numbers, which is particularly beneficial in developing countries where consumers may be unable to afford purchasing items in bulk.

A unit dose cleaning product typically comprises a water-soluble pouch that is filled with one or more cleaning compositions (e.g., a powdered detergent, a liquid rinse aid, etc.). The exterior walls of the water-soluble pouch are typically very thin and thus susceptible to damage, particularly during transport and storage. If the water-soluble pouch is exposed to water, water vapor, oxygen, and/or other potentially corrosive elements during storage and/or transport, there is a chance that the water-soluble pouch may prematurely dissolve and release its contents. Furthermore, shifting and contact with other items during transport may inadvertently puncture the relatively thin skin of the water-soluble pouch.

These concerns are typically addressed by packaging the unit dose cleaning product in a protective container. However, such containers are typically sized to contain a large quantity of unit dose cleaning products, and consequently, may be too expensive or inconvenient to store for consumers in developing countries or other low income markets. Furthermore, conventional protective containers usually are not biodegradable and/or re-usable. Still further, unit dose cleaning products are typically loosely packed in the protective container, thus increasing the risk that the unit dose cleaning products will rub against each other and inadvertently burst. While it is possible to package each unit dose cleaning product in its own protective container, in some circumstances, such individualized packaging is not feasible and/or too costly. Also, individualized packaging increases the potential for litter, which can be problematic in developing countries and other places where garbage removal services are not prevalent.

### SUMMARY

One aspect of the present disclosure includes a product container including a protective housing having a hollow interior and a web arranged in the hollow interior. The web includes a plurality of water-soluble or otherwise degradable (e.g., UV degradable) pouches removably attached to each other. Each of the water-soluble pouches contains at least one cleaning composition. The web is formed in a roll or a z-folded configuration with a plurality of folds.

Another aspect of the present disclosure provides a product container having a protective housing defined by a plurality of walls that enclose a hollow interior. An opening is formed in at least one of the plurality of walls of the protective housing. A web is arranged in the hollow interior of the protective housing and includes a plurality of water-soluble pouches removably attached to a flexible carrier sheet. Each of the water-soluble pouches contains at least one cleaning composition. The product container also includes a means for dispensing the web through the opening in the protective housing.

Yet another aspect of the present disclosure provides a product container including a water-insoluble protective sleeve extending along a longitudinal axis and a plurality of water-soluble pouches arranged adjacent one another along the longitudinal axis. Each of the water-soluble pouches contains at least one cleaning composition. Also, each of the water-soluble pouches forms a friction fit with one or more interior walls of the water-insoluble protective sleeve to inhibit movement of the water-soluble pouch along the longitudinal axis. A re-sealable plug is arranged to cover an open end of the water-insoluble protective sleeve.

### BRIEF DESCRIPTION OF THE DRAWINGS

FIG. 1 is a perspective view of one embodiment of a product container constructed in accordance with principles of the present disclosure.

FIG. 2 is perspective view of a portion of a web illustrated in FIG. 1.

FIG. 3 is a cross-sectional view of the water-soluble pouches depicted in FIG. 1.

FIG. 4 is a top view of a portion of the web shown in FIG. 1.

FIG. 5 is a perspective view of another embodiment of the web.

FIG. 6 is a perspective view of yet another embodiment of the web.

FIG. 7 is a perspective view of another embodiment of a product container constructed in accordance with principles of the present disclosure.

FIG. 8 is a perspective view of another embodiment of a product container constructed in accordance with principles of the present disclosure.

### DETAILED DESCRIPTION

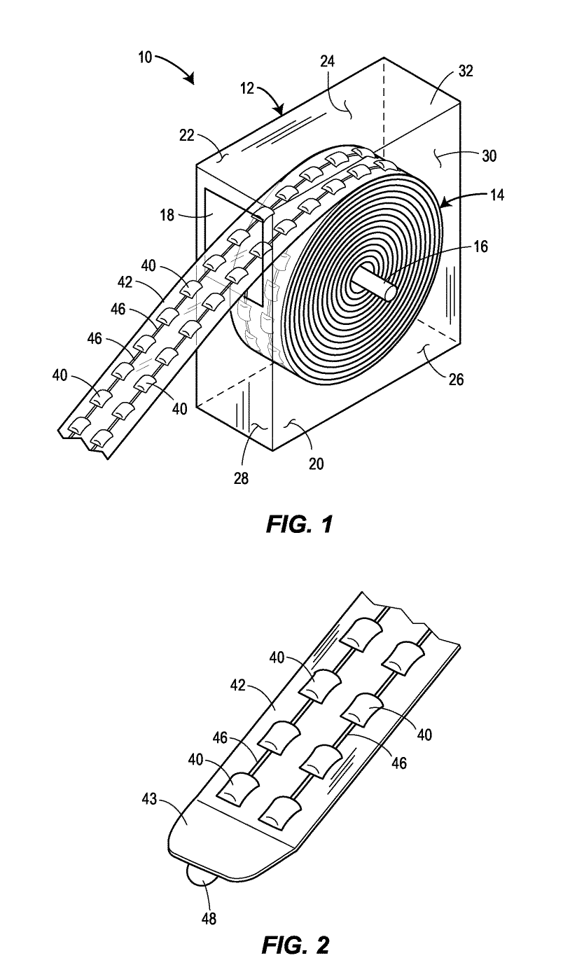

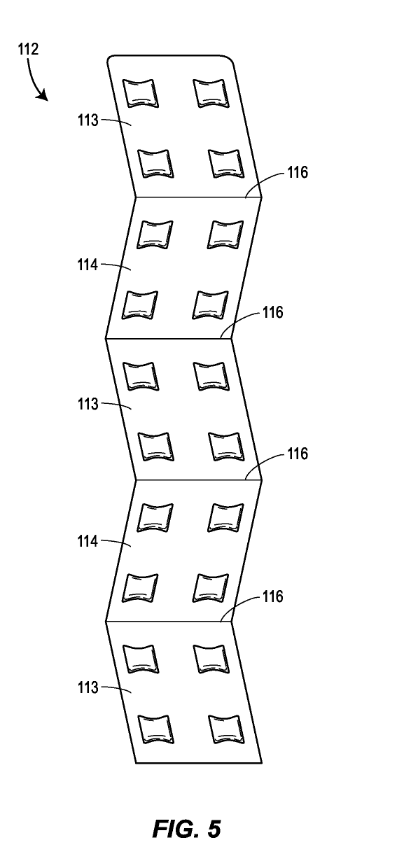

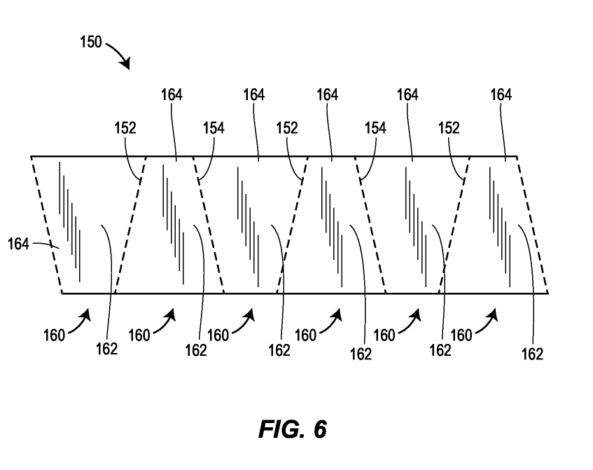

FIG. 1 illustrates one possible embodiment of a product container 10 which can be used to store and dispense a plurality of unit dose products in accordance with principles of the present disclosure. The product container 10 may include a protective housing 12 that encloses a web 14 comprising the unit dose products. The web 14 may be wound around an axle 16 in the form of a roll. Alternatively, the web 14 may be z-folded with a plurality of folds, as discussed below in connection with FIGS. 5 and 6. Removal of the web 14 from the protective housing 12 is accomplished by pulling the web 14 through an opening 18 in the protective housing 12. So configured, the product container 10 of the present disclosure advantageously protects the unit dose products from damage during storage and/or transport and dispenses the unit dose products in an efficient manner.

Each of the foregoing elements of the product container 10 will now be described in more detail. Although the following text describes various embodiments of various components and materials that may be used in connection with the product container 10 of the present disclosure, the claims of this application are not limited to the particular embodiments described below.

Referring to FIG. 1, the protective housing 12 possesses a plurality of walls 20, 22, 24, 26, 28, and 30 which enclose and define a hollow interior 32 of the protective housing 12. Each of the walls 20, 22, 24, 26, 28, and 30 is planar and together define a box shape. Other embodiments can be arranged differently, for example, with some or all of the walls 20, 22, 24, 26, 28, and 30 being curved and/or with a fewer or greater number of walls. In some embodiments, the protective housing 12 may have a spherical or hemispherical shape. The protective housing 12 may be made of fiberboard, cardboard, plastic, metal, or any other suitably rigid material. In one embodiment, the protective housing 12 is made a corrugated material (e.g., corrugated fiberboard, corrugated cardboard, etc.). Additionally, the protective housing 12 may be made of a biodegradable material such as, for example, fiberboard and/or cardboard, so that the environmental impact of disposing the protective housing 12 is minimized. The biodegradable aspect of the protective housing 12 may be particularly beneficial in developing countries where consumers may not have access to garbage removal services. In some embodiments, the protective housing 12 may be manufactured from a translucent and/or transparent material so that the web 14 is partially and/or fully visible through the protective housing 12. Such a configuration may allow an individual to see inside the protective housing 12 and determine the number of remaining water-soluble pouches 40.

In use, the protective housing 12 provides a barrier that prevents external objects from contacting, and potentially puncturing, the water-soluble pouches 40. The protective housing 12 may also provide a sealed atmosphere that limits and/or prevents oxygen, water vapor, and/or other liquids and gases from eroding the water-soluble pouches 40. In one embodiment, the exterior of the protective housing 12 is shrink-wrapped with a plastic sheet so that the hollow interior 32 is sealed off from the outside atmosphere.

The opening 18 may be formed in the wall 28 of the protective housing 12 and may be sized and dimensioned so that the web 14 can be removed from the protective housing 12 through the opening 18. The opening 18 may be formed in any one of, or combination of, the walls 20, 22, 24, 26, 28, and 30. In some embodiments, the protective housing 12 may have more than one opening. Additionally, in some embodiments, the protective housing 12 may include a door (not illustrated) that covers the opening 18 and which can be removed to gain access the hollow interior 32 of the protective housing 12. The door may be formed by a serrated portion of the wall 28 that can be manually torn away by an individual. In some embodiments, the door may be hinged so that the door can be opened and closed, thereby sealing and unsealing the hollow interior 32 of the protective housing 12.

The web 14 may include a plurality of water-soluble pouches 40 removably attached to a flexible carrier sheet 42. Each of the water-soluble pouches 40 may be filled, partially or entirely, with a cleaning composition 44. Each water-soluble pouch 40, in combination with its cleaning composition 44, may constitute a unit dose product. Any number of water-soluble pouches 40 may be arranged on the flexible carrier sheet 42, including, in some embodiments, 30-50 water-soluble pouches 40, or lesser or greater. As illustrated in FIG. 1, the water-soluble pouches 40 may be arranged in two rows extending along the length of the flexible carrier sheet 42. Other embodiments may arranged differently, for example, with a single row of water-soluble pouches 40, three or more rows of water-soluble pouches 40, a patterned arrangement of the water-soluble pouches 40, and/or a random arrangement of the water-soluble pouches 40. Each of the water-soluble pouches 40 may be connected to one or more immediately adjacent water-soluble pouches 40 by one or more connecting members 46. As discussed below in more detail, the connecting members 46 may be integrally formed (e.g., formed in one-piece) with the water-soluble pouches 40.

In some embodiments, an adhesive is used to removably attach the water-soluble pouches 40 to the flexible carrier sheet 42. The adhesive may be a low tack peelable adhesive (e.g., a UV-curable acrylic oligomer). The adhesive may be applied to the water-soluble pouches 40 and/or the connecting members 46. It may be advantageous to apply the adhesive only to the connecting member 46 so as to avoid the possibility of the adhesive tearing the water-soluble pouches 40 when the water-soluble pouches 40 are removed from the carrier sheet 42. As an alternative to the adhesive, or as an addition to the adhesive, fasteners may be used to removably attach the water-soluble pouches 40 to the flexible carrier sheet 42 such as, for example, bendable wires, staples, and/or strings. In an embodiment utilizing staples, the staples may fix the connecting members 46 to the flexible carrier sheet 42.

The flexible carrier sheet 42 may be made from various flexible materials such as paper, plastic, silicone, rubber, and/or any combination of these materials. In some embodiments, the flexible carrier sheet 42 is made of a paper material that is both air and water resistant such as, for example, glassine paper and/or silicone release paper. The flexible carrier sheet 42 may be translucent and/or transparent so that the water-soluble pouches 40 are partially and/or fully visible through the flexible carrier sheet 42. In some embodiments, the flexible carrier sheet 42 may be made of a biodegradable material such as a biodegradable paper, a biodegradable plastic, or a combination of both. In other embodiments, the carrier sheet 42 could be made of a water-soluble film, having the same or a different degree of water-solubility as the pouches 40 dictated by its material formulation or thinness, for example. While the embodiment illustrated in FIG. 1 utilizes a single flexible carrier sheet, other embodiments may be configured with two flexible carrier sheets, with the water-soluble pouches 40 sandwiched between the two flexible carrier sheets.

Referring to FIG. 2, a lip 43 may be formed by the front end of the flexible carrier sheet 42. The lip 43 may include a tab 48 to help an individual grip the flexible carrier sheet 42 and manually pull the flexible carrier sheet 42 away from the water-soluble pouches 40.

The material for the walls of the water-soluble pouches 40 may be hot and/or cold-water soluble or dispersible, and may be flexible or rigid. A cold-water soluble material is one that is soluble in water at 20° C. or less, while a hot-water soluble material is one which is soluble in water at 60° or more. Material which is soluble between these temperatures can also be used. A water-soluble pouch 40 made of a cold-water soluble material may release its contents in 3 minutes or less when placed in un-agitated water at 20° C. or less. A water-soluble pouch 40 made of a hot-water soluble material may release its contents in 3 minutes or less when placed in un-agitated water at 60° or more. In some embodiments, the water-soluble pouches 40 are made of a film, or a combination of two different films, each of which may be a mono-layer or a laminated film, which is both water-soluble and flexible. The water-soluble pouches 40 may be made from films of different grades, of different thicknesses, and/or from films which have been perfumed and/or colored to obtain aesthetically pleasing characteristics, or from any combination of these features.

Preferred materials for the water-soluble pouches 40 include polyvinyl alcohol (PVOH), cellulose derivatives such as cellulose ethers (e.g., hydroxypropyl methyl cellulose (HPMC)), polyglycolides, polylactides, and/or polylactide-polyglycolide copolymers. The PVOH may be partially or fully hydrolyzed homopolymer of polyvinyl acetate (e.g. a copolymer of vinyl alcohol groups and vinyl acetate groups, or all vinyl alcohol groups); additionally the PVOH may a partially or fully hydrolyzed modified PVOH (for example 1-10 mole % anionic copolymer comprising groups such as monomethyl maleate sodium salt or 2-Acrylamido-2-methylpropane sulfonate sodium salt. For example, the PVOH may be alcoholised or hydrolysed in a range between 40-100%, or between 70-92%, or between 88-92%. The degree of hydrolysis is known to influence the temperature at which the PVOH starts to dissolve in water. 88% hydrolysis corresponds to a film soluble in cold (e.g., room temperature) water, whereas 92% hydrolysis corresponds to a film soluble in warm water. The material for the water-soluble pouches 40 may also, in various embodiments, contain plasticizers and mold release agents, which may facilitate the manufacturing of the water-soluble pouches 40, and/or other components such as coloring agents. The material may be produced by any process including, for example, extrusion, blowing, and/or casting. The material may be un-oriented, mono-axially oriented, or bi-axially oriented. If the layers in the film are oriented, they usually have the same orientation, although their planes of orientation may differ.

The thickness of the walls of the water-soluble pouches 40 may be in a range between 20-500 μm, or between 30-300 μm, or between 35-200 μm, or between 40-160 μm, or between 40-150 μm, or between 40-120 μm. In one embodiment, the water-soluble pouches 40 may be made of a PVOH film available as MonoSol M8630 (ex. MonoSol, LLC) and may have a thickness of approximately (e.g., ±10%) 75 μm.

The cleaning composition 44 may be a dishwashing detergent, a laundry detergent, a water softener, a rinse aid, a surface cleaner, etc. The cleaning composition 44 may take any appropriate form including, but not limited to, a liquid, a gel, a paste, a solid, granules, and/or a powder. Each of the water-soluble pouches 40 may be divided into multiple chambers (not illustrated) by internal walls so that the water-soluble pouch 40 can hold, and keep separate, multiple cleaning compositions. For example, one of more of the water-soluble pouches 40 may have a first chamber filled with a powered dishwashing detergent and a second chamber filled with a liquid rinse aid. The internal walls forming the different chambers may have different thicknesses so that the first and second chambers release their respective compositions at different times during, for example, an automatic dishwasher cleaning cycle.

In some embodiments, each of the water-soluble pouches 40 may be divided into sub-pouches by internal walls (not illustrated), with the sub-pouches being separable from each other. Each of the sub-pouches may be filled with the same type of cleaning composition 44. Accordingly, a user can break or tear away one of the sub-pouches for use in a cleaning application that requires less than the total amount of cleaning composition 44 contained in the water-soluble pouch 40.

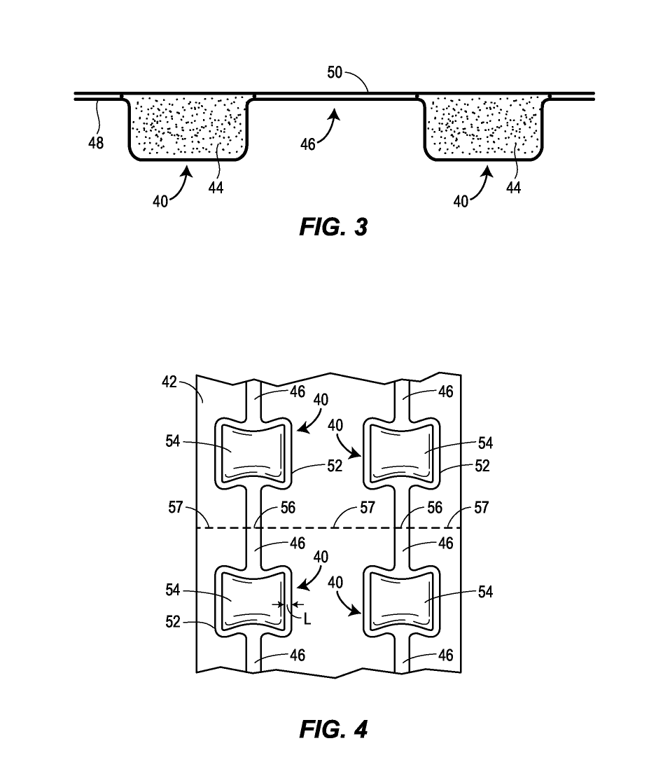

To manufacture the water-soluble pouches 40, a first sheet of material 48 (e.g., a PVOH film) may be thermoformed and/or vacuum formed with a plurality of depressions arranged along one or more rows. The depressions may be filled with the cleaning composition 44, and then a second sheet of material 50 (e.g., a PVOH film) may be sealed to the first sheet of material around the perimeter of each of the depressions, as depicted in FIG. 3. The excess material surrounding each of the depressions may be cut (e.g., die cut) to form the shape of the individual water-soluble pouches 40. In some embodiments, the excess material that spans the distance between each of the water-soluble pouches 40 may be left in place so that this material can form the connecting members 46. As such, the connecting members 46 may be integrally formed (e.g., formed in one-piece) with the water-soluble pouches 40. In other embodiments, the connecting members 46 may be a separate component from the water-soluble pouches 40, and may be welded, fastened, and/or adhered to the water-soluble pouches 40 after the water-soluble pouches 40 are cut away from the sheets of material. In some embodiments, no connecting members 46 are included.

FIG. 4 illustrates that each of the water-soluble pouches 40 may be formed with a seal flange 52. The seal flange 52 may extend outwardly from a main body 54 of the water-soluble pouch 40 and may surround the main body 54 such that the seal flange 52 resembles a skirt. The length L between an outer edge of the seal flange 52 and the main body 54 may be in the range between 2-10 mm, or 3-8 mm, or 4-6 mm. The seal flange 52 may be formed by excess material that is left over after the water-soluble pouch 40 is cut from the first and second sheets of material 48, 50. In some embodiments, the seal flange 52 may be integrally formed (e.g., formed in one-piece) with the water-soluble pouches 40 and the connecting members 46, as seen in FIG. 4.

Referring still to FIG. 4, each of the connecting members 46 may be formed with a weakened tear line 56 that extends across the connecting member 46 between opposite sides of the connecting member 46. The weakened tear line 56 may help an individual to manually tear and/or cut the connecting member 46 so that adjacent water-soluble pouches 40 can be separated quickly and conveniently. The weakened tear line 56 may be formed by any suitable method including, for example, laser etching and/or scoring. Another weakened tear line 57 may be formed in the flexible carrier sheet 42 at a location that is aligned with the weakened tear line 56 of the connecting member 46 so that the weakened tear lines 56, 57 overlap each other. This configuration may help an individual simultaneously tear the flexible carrier sheet 42 and the connecting member 46. In an embodiment where the connecting members 46 are made of a PVOH film, the weakened tear lines 56 may be useful given that a PVOH film can be difficult to cut and/or tear due to its tensile strength, shear strength, ductility, and overall toughness.

The web 14 may be arranged inside the protective container 12 in a manner that allows the web 14 to be withdrawn through the opening 18 without the web 14 being inadvertently twisted and/or subjected to excessive tensile forces which could potentially damage the web 14. For example, as depicted in FIG. 1, the web 14 can be wound around itself in the form of a roll. Forming the web 14 in a roll tightly packages the water-soluble pouches 40 close to each other, which helps prevent the water-soluble pouches 40 from shifting and/or rubbing against each other during transport. The axle 16 may be cylindrically shaped and may extend through a hole in the center of the roll to rotatably support the roll. The axle 16 may extend between opposing walls 22, 26 of the protective container 24 and may be formed of a biodegradable material. The axle 16 may be removably fastened to the walls 22, 26 at opposite axial ends of the axle 16 so that the axle 16 can be removed from the protective container 12, inserted through a replacement web, and then re-installed in the protective chamber 12 together with the replacement web.

In use, the web 14 may be dispensed from the protective container 12 by pulling the leading edge of the web 14 through the opening 18 while the remainder of the web 14 rotates around the axle 16. After a desired number of water-soluble pouches 40 have been pulled through the opening 18, an individual may manually tear and/or cut the connecting members 46 and the flexible carrier sheet 42 to remove the water-soluble pouches 40 from the web 14. Subsequently, the individual may remove the water-soluble pouches 40 from the flexible carrier sheet 42 and use them in a cleaning application such as dishwashing, clothes washing, surface cleaning, etc.

FIG. 5 illustrates another version of the web that is folded instead of being wound into a roll. Here, the web 112 includes a plurality of water-soluble pouches 113 removably attached to a carrier sheet 114. The web 112 is formed with a plurality of evenly-spaced and parallel folds 116 such that web 112 is z-folded. Folding the web 112 in this manner allows the web 112 to be compactly arranged inside a protective container (not illustrated). The web 112 may be removed from the protective container by pulling the web 112 through an opening in the top of the protective container, thereby unfolding the web 112. Each of the folds 116 may be formed as a weakened tear line, for example, through scoring and/or laser etching, so that adjacent portions of the web 112 can be easily separated from each other. The water-soluble pouches 113 may not be connected to each other in this embodiment so that the web 112 can be folded properly.

In an alternative embodiment, each fold 116 illustrated in FIG. 5 may be replaced by two parallel folds, such that adjacent rows of the water-soluble pouches 113 are separated by two parallel folds. Accordingly, when the web 112 is folded, each panel of the web 112 may be spaced apart from an adjacent panel by a distance corresponding to the distance between the parallel folds arranged between the adjacent panels. Furthermore, the water-soluble pouches 113 of the adjacent panels may be staggered, such that, when the web 112 is folded, the water-soluble pouches 113 of adjacent panels do not overlap and lie on top of each other. This configuration may help reduce the overall size of the folded web 112.

Another folded version of the web is depicted in FIG. 6. The web 150 includes a first group of folds 152 alternatingly arranged with a second group of folds 154. Each fold of the first group of folds 152 is parallel to each other and non-parallel to each fold of the second group of folds 154. Each fold of the second group of folds 154 is parallel to each other and non-parallel to each fold of the first group of folds 152. The result of this arrangement of the folds 152, 154 is that every other fold is parallel to each other, and each fold is non-parallel to two immediately adjacent folds. Each of the folds 152, 154 intersects a longitudinal side edge of the web 150 at an angle. The angle may be in a range between, for example, 30-60°, in one embodiment, is 45°.

The entirety of the web 150 illustrated in FIG. 6 is formed by a plurality of immediately adjacent water-soluble pouches 160, with each water-soluble pouch 160 including a main body 162 surrounded by a seal flange 164. Each of the folds 152, 154 may be formed as a weakened tear line, for example, through scoring and/or laser etching, so that adjacent water-soluble pouches 160 can be easily separated from each other. In some embodiments, the web 160 may include a flexible carrier sheet (not illustrated) that is adhered to a rear side of the water-soluble pouches 160. The flexible carrier sheet may include folds similar to and/or overlapping the folds 152, 154. In an embodiment including a flexible carrier sheet, the water-soluble pouches 160 may be spaced apart from each other, such as the water-soluble pouches 113 illustrated in FIG. 5, and/or may be connected to each other via connecting members.

The foregoing product containers advantageously protect unit dose cleaning products during storage and transportation and dispense the unit dose cleaning products in efficient and relatively orderly manner. The product containers may be used by retailers to sell and/or distribute individual unit dose cleaning products to consumers who may otherwise be unable to afford purchasing large quantities of the unit dose cleaning products. Accordingly, the product containers can be useful in developing countries or other markets where consumers have little disposable income.

While the foregoing embodiments mount the water-soluble pouches on a flexible carrier sheet to prevent the water-soluble pouches from shifting inside the protective housing during transport, other embodiments can be arranged differently, for example, by forming a friction fit between the water-soluble pouches and one or more interior walls of the protective housing. Examples of such embodiments are described below in more detail.

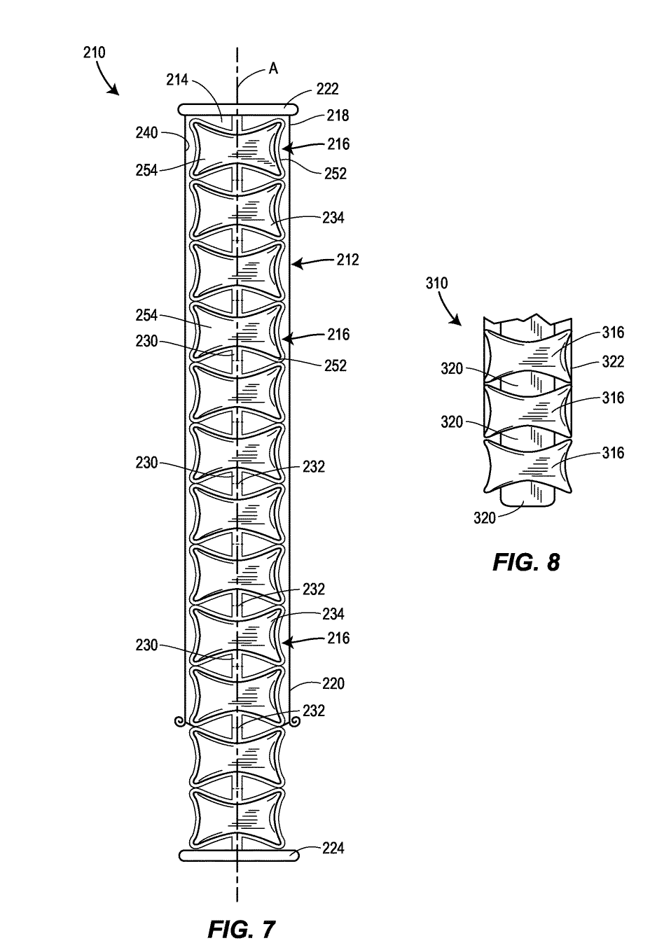

FIG. 7 illustrates an embodiment of a product container 210 including a protective sleeve 212 having a hollow interior 214 filled with a plurality of water-soluble pouches 216. The protective sleeve 212 extends along a longitudinal axis A and the water-soluble pouches 216 are arranged adjacent to each other along the longitudinal axis A. The longitudinal axis A of the protective sleeve 212 may be linear, as illustrated in FIG. 7, and/or may a follow non-linear path such as a curve. The protective sleeve 212 may be tubular and have a cross-section that is circular, oval, triangle, square, rectangle, and/or any other polygonal or curved shape. Axial ends 218, 220 of the protective sleeve 212 may have respective openings to facilitate removal and/or insertion of the water-soluble pouches 216. Re-sealable plugs 222, 224 may be arranged to cover the respective openings at the axial ends 218, 220 of the protective sleeve 212. The re-sealable plugs 222, 224 may help prevent water, water vapor, oxygen, and/or other potentially corrosive elements from entering the hollowing interior 214 of the protective sleeve 212 and prematurely dissolving the water-soluble pouches 216.

The protective sleeve 212 may be manufactured from a flexible, water-insoluble material such as plastic, rubber, laminated paper, etc. In some embodiments, the protective sleeve may be made from amorphous polyethylene terephthalate (APET). In other embodiments, the sleeve 212 could also be formed of a water-soluble film, having the same or different water solubility as the pouches 216. One benefit of making the protective sleeve 212 from a re-usable material such as plastic is that the protective sleeve 212 can filled and re-filled multiple times with water-soluble pouches 216 by the consumer and/or retailer. Accordingly, the protective sleeve 212 does not have to be disposed after a single use, thus making the protective sleeve 212 more environmentally friendly. And, in the case of a water-soluble or otherwise degradable sleeve 212, the sleeve 212 could be disposed of without generating any waste at all. Also, the protective sleeve 212 may be transparent and/or translucent so that an individual can see how many water-soluble pouches 216 are inside the protective sleeve 212 without having to open the protective sleeve 212. The re-sealable plugs 222, 224 may be made from any suitable material including polypropropylene and/or nylon.

The water-soluble pouches 216 may be constructed in the same manner and from the same material (e.g., thermoformed PVOH film(s)) as the water-soluble pouches 40 discussed above. In some embodiments, the water-soluble pouches 216 may be connected to each other by connecting members 230. The connecting members 230 may be formed from the same sheet(s) of material as the water-soluble pouches 216 such that the connecting members 230 are integrally formed (e.g., formed in one-piece) with the water-soluble pouches 216. The connecting members 230 allow the water-soluble pouches 216 to be pulled as a group from one of the axial ends 218, 220 of the protective sleeve 212.

Each of the connecting members 230 may be formed with a weakened tear line 232 that extends across the connecting member 230 between opposite sides of the connecting member 230. The weakened tear line 232 may help an individual manually tear and/or cut the connecting member 230 so that adjacent water-soluble pouches 216 can be separated quickly and conveniently. The weakened tear line 232 may be formed by any suitable method including, for example, laser etching and/or scoring.

Each of the water-soluble pouches 216 may be filled with a cleaning composition 234. Each water-soluble pouch 216, in combination with its cleaning composition 234, may constitute a unit dose product. The foregoing discussion about the characteristics and properties of the cleaning composition 44 also applies to the cleaning composition 234. The cleaning composition 234 may be a dishwashing detergent, a laundry detergent, a water softener, a rinse aid, a surface cleaner, etc. In some embodiments, the cleaning composition 234 may even be a water purifying agent for transforming dirty water into safe drinking water. Examples of such water purifying agents are disclosed in U.S. Pat. Nos. 5,023,012, 5,681,475, and 6,827,874, each of which is hereby incorporated by reference in its entirety.

The cleaning composition 234 may take any appropriate form including, but not limited to, a liquid, a gel, a past, a solid, granules, and/or a powder. Each of the water-soluble pouches 216 may be divided into multiple chambers (not illustrated) by internal walls that each contain a different cleaning composition. For example, a water-soluble pouch may have a first chamber filled with a powered dishwashing detergent and a second chamber filled with a liquid rinse aid. The walls forming the different chambers may have different thicknesses so that the chambers release their respective compositions at different times.

As illustrated in FIG. 6, the water-soluble pouches 216 and the protective sleeve 212 are sized so that the water-soluble pouches 216 are pressed firmly against an interior wall 240 of the protective sleeve 212. The interior wall 240 engages opposite sides of each of the water-soluble pouches 216 so that the interior wall 240 grasps and/or squeezes each of the water-soluble pouches 216. This arrangement results in a friction fit between the water-soluble pouches 216 and the interior wall 240 which inhibits movement of the water-soluble pouches 216 along the longitudinal axis A. Accordingly, the water-soluble pouches 216 are less likely to shift and/or rub against each other during transport. The friction fit between the water-soluble pouches 216 and the interior wall 240 of the protective sleeve 212 may provide enough resistance to prevent the water-soluble pouches 216 from falling through the protective sleeve 212 under the pull of gravity, yet loose enough to allow an individual to manually pull the water-soluble pouches 216 from the protective sleeve 212.

Referring still to FIG. 7, each of the water-soluble pouches 216 may be formed with a seal flange 252. The seal flange 252 may extend outwardly from a main body 254 of the water-soluble pouch 216 and may surround the main body 254 such that the seal flange 252 resembles a skirt. The length between an outer edge of the seal flange 252 and the main body 254 may be in the range between 3-5 mm. The seal flange 252 may be formed by excess material that is left over after the water-soluble pouch 216 is cut from one or more sheets of material. In some embodiments, the seal flange 252 is integrally formed (e.g., formed in one-piece) with the water-soluble pouches 216 and the connecting members 230. The seal flange 252 may be pressed against the interior wall 240 of the protective sleeve 212 and improve the friction fit between the water-soluble pouch 216 and the interior wall 240 of the protective sleeve 212. The seal flange 252 may elastically deform to provide a tight fit between water-soluble pouch 216 and the protective sleeve 212, thereby enabling the water-soluble pouch 216 to be fitted with various protective sleeves having different internal diameters or widths.

Furthermore, the elasticity of the seal flange 252 may have a dampening (e.g., cushioning) effect on vibrations and/or mechanical shocks experienced by the water-soluble pouches 216 during transport, thereby reducing the likelihood that the water-soluble pouches 216 will prematurely burst inside the protective sleeve 212. The dampening effect of the seal flange 252 also advantageously protects against the hydraulic hammer effect that tends to occur when the water-soluble pouches 216 are filled with liquid (e.g., a liter or more of liquid). In such embodiments, abrupt movement of the water-soluble pouch 216 can result in a shock wave that propagates through the liquid. This shock wave can potentially damage the water-soluble pouch 216. By dampening mechanical shocks experienced by the water-soluble pouch 216, the seal flange 252 makes it less likely that the liquid will impact the interior walls of the water-soluble pouch 216 with damaging force, thus diminishing or eliminating the hydraulic hammer effect. Such benefits could enable large scale pouches 216 to be more readily realized without concern for the detrimental effects of hydraulic hammering, for example.

FIG. 8 illustrates a portion of a product container 310 that configured in the same manner as the product container 210, except that the product container 310 includes water-soluble pouches 316 which are not connected to each other by connecting members. Instead, the water-soluble pouches 316 are formed with tabs 320 that allow an individual to grip the water-soluble pouches 316 and manually pull them one-by-one from the protective sleeve 322.

While the various pouches and secondary packaging components have been described herein as primarily being constructed of water-soluble materials, other degradable materials such as UV degradable materials, enzyme degradable materials, or any other materials that are degradable could foreseeably be used for any or all of the disclosed components.

The product containers 210 and 310 advantageously provide re-usable containers for unit dose cleaning products that protect against potentially corrosive environmental elements, as well as, mechanical damage. The re-usable aspect of the product containers is particularly beneficial in developing countries where disposal and cost concerns are oftentimes paramount.

While the present disclosure has been described with respect to certain embodiments, it will be understood that variations may be made thereto that are still within the scope of the appended claims.

1. A product container comprising:
a protective housing having a hollow interior;
a web arranged in the hollow interior of the protective housing, the web including a plurality of degradable pouches removably attached to each other, each of the degradable pouches containing at least one cleaning composition; and
the web being formed in a roll or a z-folded configuration with a plurality of folds.

2. The product dispenser of claim 1, wherein the degradable pouches include water-soluble pouches.

3. The product dispenser of claim 1, and a flexible carrier sheet to which the pouches are removably attached.

4. The product dispenser of claim 1, the protective housing being defined by a plurality of walls, at least one of the walls being planar.

5. The product dispenser of claim 4, at least one of the walls having an opening dimensioned to allow the web to be removed from the protective housing through the opening.

6. The product dispenser of claim 2, the water-soluble pouches being made of a polyvinyl alcohol (PVOH) film.

7. The product dispenser of claim 2, the water-soluble pouches being arranged in at least two rows extending along the flexible carrier sheet.

8. The product dispenser of claim 3, the flexible carrier sheet being formed of glassine paper.

9. The product dispenser of claim 2, the water-soluble pouches being arranged in at least one row and connected to each other by a plurality of connecting members.

10. The product dispenser of claim 9, the water-soluble pouches and the connecting members being integrally formed with each other.

11. The product dispenser of claim 10, at least some of the connecting members including a weakened tear line to allow adjacent water-soluble pouches to be separated from each other.

12. The product dispenser of claim 1, the protective housing being made of a biodegradable material.

13. The product dispenser of claim 1, comprising an axle extending between opposing walls of the protective housing, the web being wound around the axle.

14. The product dispenser of claim 2, the water-soluble pouches being made of a thermoformed film.

15. The product dispenser of claim 1, the cleaning composition being at least one of a dishwashing detergent, a laundry detergent, a water softener, or a rinse aid.

16. The product dispenser of claim 1, wherein the degradable pouches comprise UV degradable pouches.

17. The product dispenser of claim 1, the plurality of folds being parallel to each other.

18. The product dispenser of claim 1, the plurality of folds including a first group of folds alternatingly arranged with a second group of folds, the first group of folds being parallel to each other and non-parallel to the second group of folds, the second group of folds being parallel to each other and non-parallel to the first group of folds.

19. A product container comprising:
a protective housing defined by a plurality of walls enclosing a hollow interior;
an opening formed in at least one of the plurality of walls of the protective housing;
a web arranged in the hollow interior of the protective housing, the web including a plurality of water-soluble pouches removably attached to a flexible carrier sheet, each of the water-soluble pouches containing at least one cleaning composition; and
a means for dispensing the web through the opening in the protective housing.

20. The product dispenser of claim 19, the means for dispensing the web comprising an axle extending between opposing walls of the protective housing and through an opening formed in a center of the web.

21. The product dispenser of claim 19, the means for dispensing the web comprising a z-folded configuration formed by a plurality of folds in the web.

22. A product container comprising:
a water-insoluble protective sleeve extending along a longitudinal axis;
a plurality of water-soluble pouches arranged adjacent one another along the longitudinal axis, each of the water-soluble pouches containing at least one cleaning composition and forming a friction fit with one or more interior walls of the water-insoluble protective sleeve to inhibit movement of the water-soluble pouches along the longitudinal axis; and
a re-sealable plug arranged to cover an open end of the water-insoluble protective sleeve.

23. The product container of claim 22, each of the water-soluble pouches including a main body containing the cleaning composition and a flange extending outwardly from the main body in the form of a skirt.

24. The product container of claim 22, each of the water-soluble pouches being made of a polyvinyl alcohol (PVOH) film.

25. The product container of claim 22, the water-insoluble protective sleeve having a circular cross section.

26. The product container of claim 22, the sleeve is water-soluble.

27. The product dispenser of claim 22, the sleeve is water-insoluble.
